(19) United States
(12) Patent Application Publication
(10) Pub. No.: US 2012/0075636 A1
(43) Pub. Date: Mar. 29, 2012

(54) Tunable optical filters using cascaded etalons

(76) Inventor: Aaron J. Zilkie, Painted Post, NY (US)

(21) Appl. No.: 12/924,218

(22) Filed: Sep. 23, 2010

(51) Int. Cl. G01B 9/02

(52) U.S. Cl. 356/454

(57) ABSTRACT

A temperature-tuned dielectric-slab-etalon scanning spectrometer that is low cost and simple to fabricate uses cascaded etalon modules, each module comprising a Fabry-Perot (FP) etalon having a relatively small Free Spectral Range (FSR), with at least two modules provided with a temperature control. According to the invention, the multiple FP modules produce Vernier tuning control. In these devices, the tuning temperature range is typically less than 10° C., and the required slab thickness may be less than 1 mm. This reduces fabrication and material requirements, and results in lower device cost and improved reliability.

### FIELD OF THE INVENTION

The field of the invention is optical filtering. More specifically, it is directed to tunable optical filters using cascaded etalons.

### BACKGROUND OF THE INVENTION

Tunable optical filters are devices for optical frequency selection. They are used in a wide range of applications, such as selecting laser cavity modes in tunable lasers, creating narrow-band tunable light sources, adding or dropping optical signals of different frequencies from a spectrally multiplexed beam, or making sweeping spectrometers. A common architecture of a tunable optical filter, attractive because of its low cost, is a tunable Fabry-Perot (FP) etalon. In the tunable FP etalon architecture, the resonance frequency of the device is tuned by changing the cavity optical path length, either by changing the refractive index of the medium in the etalon cavity, or by changing the length of the etalon cavity. Common low-cost implementations of an optical-fiber-based tunable Fabry-Perot etalon are i) a free-space dielectric slab in which the resonance of the dielectric slab is tuned by temperature, ii) a gap between two cleaved fiber ends, with the gap distance tunable by the piezo-electric effect, and iii) a liquid-crystal slab in which the index of the liquid crystal is changed by an applied variable electric voltage.

For many widely used applications a large free-spectral-range (FSR) is required. An important application, a C-band scanning spectrometer, requires an FSR which is greater than the C-band (>5 THz), so that at all tuning points it only passes one segment of the C-band spectrum. For applications requiring low-cost and high reliability, tunable filter implementations identified as category ii) above have the disadvantage that the piezoelectric effect suffers from hysteresis, sticking, and unrepeatability over life. Implementation identified as iii) above presents difficult challenges in manufacture, involving for example engineering the parallelism and reflectivity of the reflective surfaces in the presence of coated dielectric electrodes. Another category of tunable filters found in industry are tunable planar-lightwave-circuit (PLC) ring resonator filters. In the ring-resonator architecture the resonance can be tuned by temperature, or by changing the material above the ring that is seen by the evanescent optical field. However, this architecture suffers from the primary disadvantage that PLC devices are costly to fabricate. Finally, recent industry mass-deployment of tunable dispersion compensators based on precisely-temperature-tuned dielectric slab etalons, has lowered the cost of fiber lens collimators, and the cost of packaging of fiber/dielectric-slab etalon devices. The temperature-tuned dielectric slab implementation is thus the focus of this invention, due to simplicity and reliability combined with good performance.

For applications of main interest, a challenge that remains with temperature-tuned dielectric slab devices is the large temperature range required to sweep the filter over the entire frequency band of interest, for example, 5 THz to sweep the C-band as mentioned above. For temperature tuned dielectric slab devices, silicon is the industry-standard substrate material. Typically, temperature ranges of >300° C. are required to tune a silicon slab filter over 5 THz. The structure also requires a stack of 10 to 20 thin layers of materials with differing refractive indicies. To avoid structural degradation these layers require thermal expansion coefficients that precisely match that of the silicon substrate. For applications such as optical channel monitoring (OCM) in multiplexed optical communications networks, one sweep every few seconds over a device lifetime of 15-20 years may be used. Complex and expensive fabrication processes are required to construct and package such a structure so that it does not exhibit performance degradation or failure with such stressful temperature cycling. Additionally, fabrication is complicated by the requirement that the thickness of the slab must be large (e.g., ˜10 mm) for an FSR of 5 THz.

### STATEMENT OF THE INVENTION

A temperature-tuned dielectric-slab-etalon scanning spectrometer that is low cost and simple to fabricate uses cascaded etalon modules, each module comprising a Fabry-Perot (FP) etalon having a relatively small Free Spectral Range (FSR), with at least two modules provided with a temperature control. According to the invention, the multiple FP modules produce Vernier tuning control. Devices with this characteristic are referred to below as Vernier Tuning Fabry-Perot Filters (VTFPFs). In these devices, the tuning temperature range may be less than 10° C., and the required slab thickness may be less than 1 mm. This drastically reduces the fabrication and material requirements, and results in lower device cost and improved reliability.

### BRIEF DESCRIPTION OF THE DRAWING

The invention may be more easily understood when considered in conjunction with the drawing in which:

FIG. 1 is a schematic diagram illustrating the operation of a typical FP etalon;

FIG. 2 is a schematic representation of a two module VTFPF using cascaded FP etalons with individual temperature controls;

FIG. 3 is a schematic representation, similar to that of FIG. 2, of a three module VTFPF;

FIG. 4 is a plot showing simulated filter transmittances for the VTFPF described in connection with FIG. 2;

FIG. 5 is a plot showing a portion of FIG. 4 in more detail;

FIG. 6 is a plot showing enhanced adjacent channel rejection for the main resonance of FIG. 5;

FIG. 7 is a plot showing simulated filter transmittances for the VTFPF described in connection with FIG. 3;

FIG. 8 is a plot showing a portion of FIG. 7 in more detail;

FIG. 9 is a plot of frequency vs. transmission for a two etalon VTFPF illustrating the shift in the resonance peak as a result of temperature change;

FIGS. 10 and 11 are plots of temperature vs. frequency for each of two etalons showing multiple cycles in a scan;

FIGS. 12 and 13 are plots of the temperature difference between the two etalons during the frequency scan of FIGS. 10 and 11;

FIGS. 14 and 15 are plots showing the change in FSR of the two etalons during the frequency scan of FIGS. 10 and 11;

FIG. 16 is a plot similar to that of FIGS. 10 and 11 for a coarse scan using fewer cycles; and

FIG. 17 is a plot showing the change in FSR during the scan of FIG. 16.

### DETAILED DESCRIPTION OF THE INVENTION

The etalons in the VTFPF devices of the invention are shown as Fabry-Pérot etalons operating according to known principles of optics. A Fabry-Pérot etalon is typically made of a transparent plate with two reflecting surfaces. An alternate design is composed of a pair of transparent plates with a gap in between, with any pair of the plate surfaces forming two reflecting surfaces. From the standpoint of cost and manufacturability the preferred plate material is silicon. The transmission spectrum of a Fabry-Pérot etalon as a function of wavelength exhibits peaks of large transmission corresponding to resonances of the etalon.

Referring to FIG. 1, light enters the etalon and undergoes multiple internal reflections. The varying transmission function is caused by interference between the multiple reflections of light between the two reflecting surfaces. Constructive interference occurs if the transmitted beams are in phase, and this corresponds to a high-transmission peak of the etalon. If the transmitted beams are out-of-phase, destructive interference occurs and this corresponds to a transmission minimum. Whether the multiply-reflected beams are in-phase or not depends on the wavelength (λ) of the light, the angle the light travels through the etalon (θ), the thickness of the etalon (l) and the refractive index of the material between the reflecting surfaces (n).

Maximum transmission (Tₑ=1) occurs when the difference in optical path length between each transmitted beam (2nl cos θ) is an integer multiple of the wavelength. In the absence of absorption, the reflectivity of the etalon Rₑ is the complement of the transmission, such that Tₑ+Rₑ=1, and this occurs when the path-length difference is equal to half an odd multiple of the wavelength.

The finesse of the device can be tuned by varying the reflectivity of the surface(s) of the etalon. The finesse of the etalon is related to the etalon reflectivities by:

$$F = \frac{{π ( {R}_{1} {R}_{2} )}^{\frac{1}{4}}}{1 - {( {R}_{1} {R}_{2} )}^{\frac{1}{2}}}$$

where F is the finesse, R₁, R₂ are the reflectivity of facet 1 and facet 2 of etalon.

The wavelength separation between adjacent transmission peaks is the free spectral range (FSR) of the etalon, Δλ, and is given by:

Δλ=λ₀²/(2nl cos θ)

where λ₀ is the central vacuum wavelength of the nearest transmission peak. The FSR is related to the full-width half-maximum by the finesse of the etalon. Etalons with high finesse show sharper transmission peaks with lower minimum transmission coefficients.

The FSR of an etalon is temperature sensitive because the optical length of the etalon or the refractive index within the etalon is typically temperature sensitive. This temperature sensitivity, frequently unwanted, can be used to advantage, if controlled, to tune a device that incorporates an etalon.

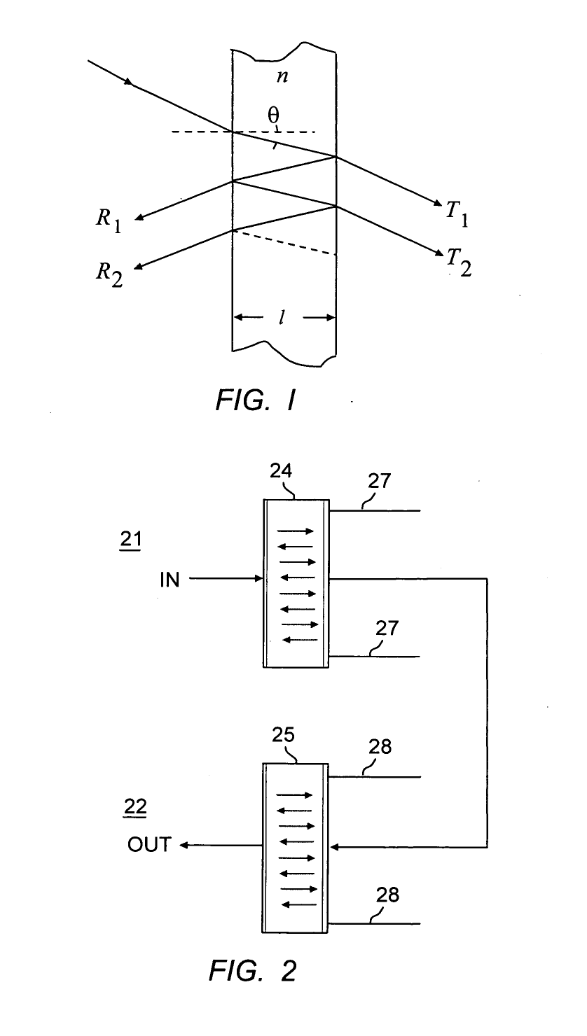

The VTFPF of this invention comprises a cascade of N>1 single Fabry-Perot etalon filter modules. An embodiment of a VTFPF is shown in FIG. 2 where N=2. Each module, 21, 22, contains an Fabry-Perot slab etalon 24, 25, and an, associated temperature control unit represented by the electrical leads 27, 28. The arrows represent the direction of the optical beam through the device. The Vernier effect of the VTFPF results from cascading multiple filter components which have FSRs with a fractional portion of the desired FSR for the overall VTFPF. The fractional portion may be 0.33 or less, preferably 0.1 or less. This allows each filter component to be tuned over a temperature range that is much smaller than that required for a single etalon by itself, typically less than 30 degrees C. Thus the temperature range of the VTFPF filter is less than or approximately equal to one tenth of the temperature range required for the known wavelength selective filters mentioned earlier, and produces a VTFPF with fine tuning capability. In this category of VTFPFs, the etalons in the VTPFP modules are designed with a FSR of less than 300 GHz, preferably less than 150 GHz, and the temperature range for tuning each module of the VTFPF is less than 20 degrees C. An important feature is that each etalon in the filter has an FSR that is slightly offset with respect to the FSR of the other etalons in the cascade. An example for the VTFPF shown in FIG. 2 is:

### Example 1

N=2 etalons

### FSR₁=100 GHz

### FSR₂=101.8 GHz

The reflectance of the facets of the etalons in this example is 0.95. The VTFPF of this example creates a filter having a scan FSR of 8 THz, and 7 dB adjacent channel rejection (ACR) for neighboring 100 GHz WDM channels.

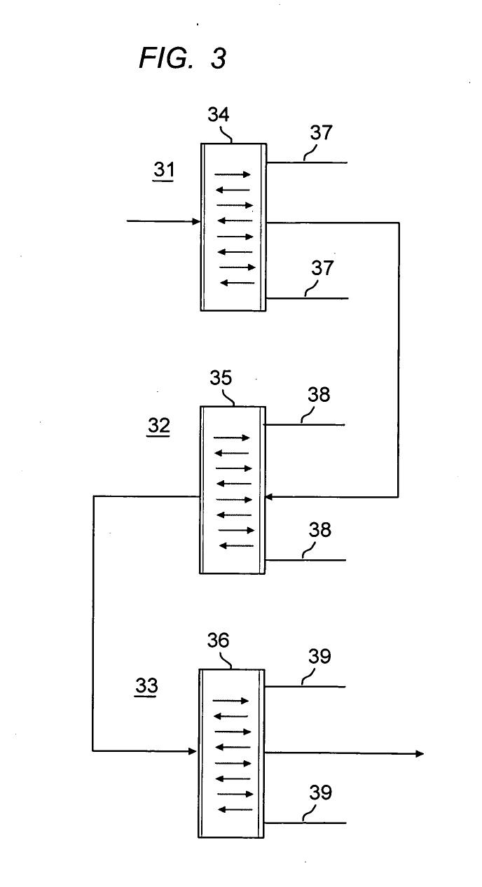

FIG. 3 shows a VTFPF device with three stages 31, 32, 33. The three stages are optically coupled serially as indicated in the figure. Each of the three stages comprises an etalon 34, 35, 36, and each is provided with an individual temperature control represented by the electrical leads 37, 38, 39. An example of the FSRs for the VTFPF of FIG. 3 is:

### Example 2

N=3 etalons

### FSR₁=100 GHz

### FSR₂=101.8 GHz

### FSR₃=103.8 GHz

The reflectance of the facets of the etalons in this example is 0.95. The VTFPF of this example has an overall FSR of 8 THz, and provides 16 dB ACR.

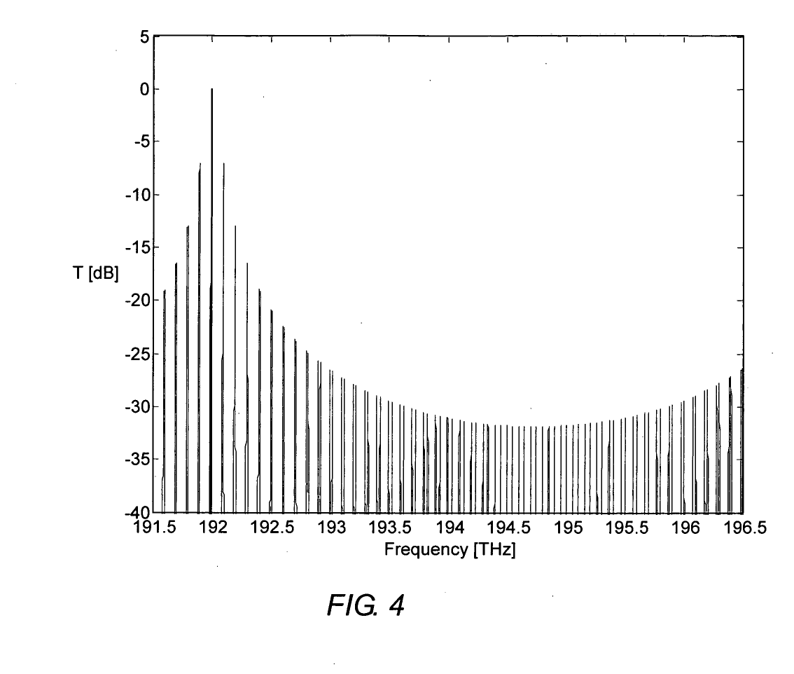

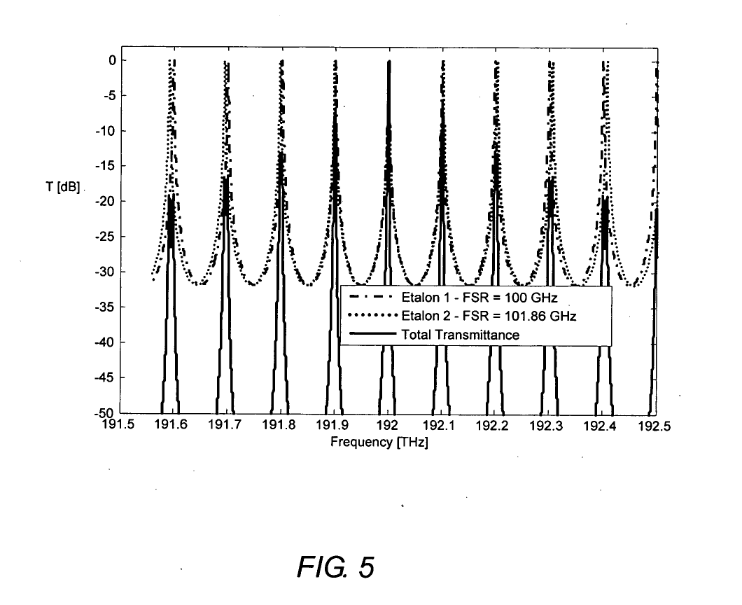

Simulated filter transmittances for the VTFPFs described above are shown in FIGS. 4-7. FIG. 4 shows transmittance over the frequency range 191.5 THz to 196.5 THz of interest, for each of the two VTFPF modules in Example 1 (designated Etalon 1 and Etalon 2), and the overall transmittance of the cascaded modules. FIG. 5 repeats the same data for just the range 191.5 THz to 192.5 THz to show with greater clarity the data near the resonance at 192 THz.

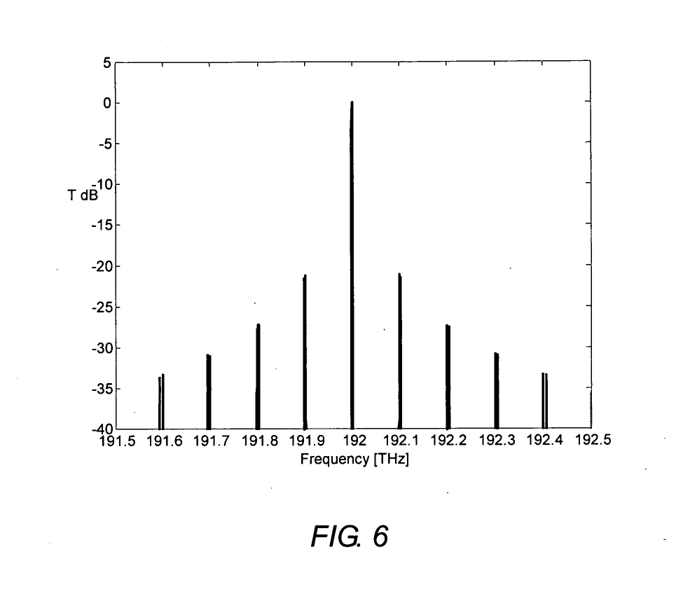

The finesse of the device may be increased by changing the reflectance of the facets from 0.95, as in Example 1, to 0.99. The result of this, for a N=2 device is shown in FIG. 6. The ACR in this case is 22 dB.

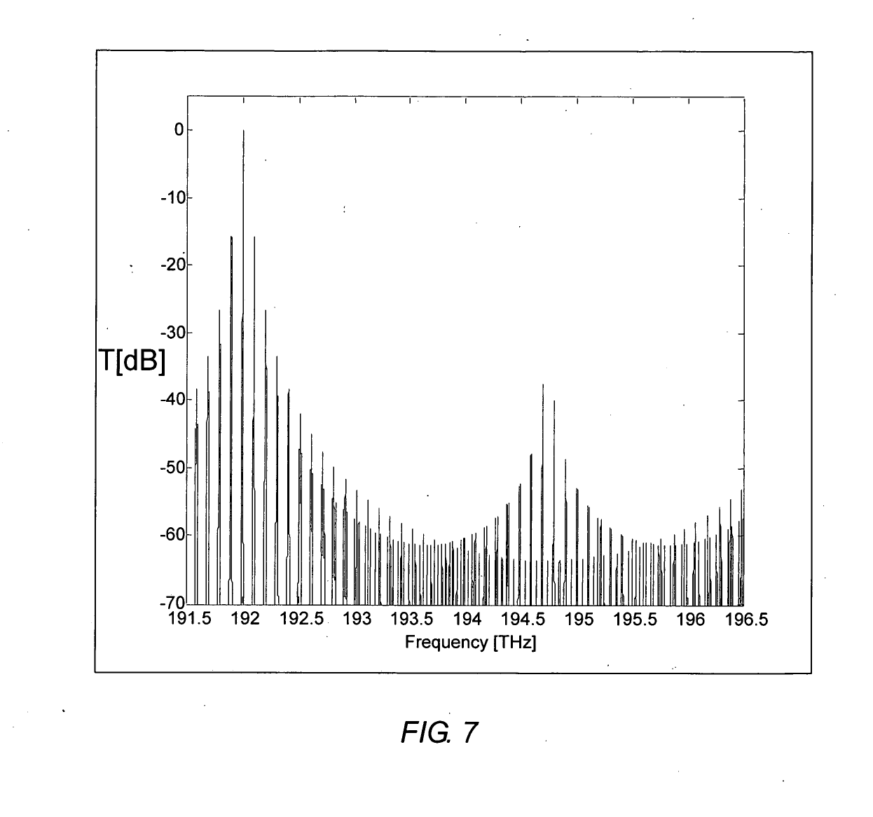

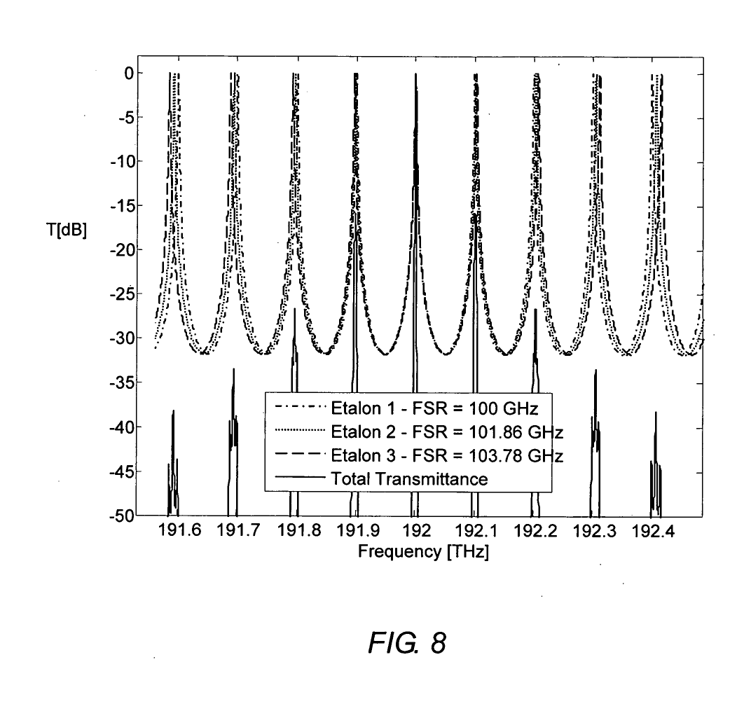

FIG. 7 shows transmittance over the frequency range 191.5 THz to 196.5 THz of interest, for each of the three VTFPF modules in Example 2 (designated Etalon 1, Etalon 2, and Etalon 3), and the overall transmittance of the three cascaded modules. FIG. 8 repeats the same data for just the range 191.5 THz to 192.5 THz to show the data near the main resonance frequency with greater clarity.

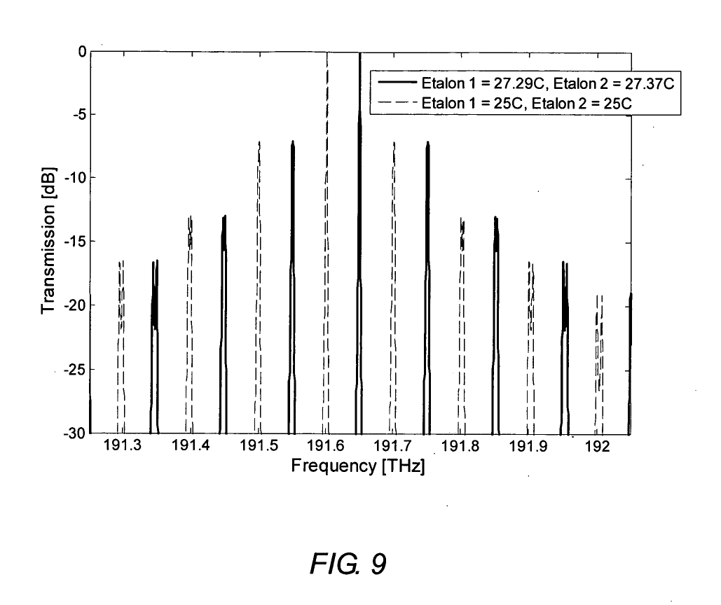

As described earlier, the main resonance frequency of the VTFPF is temperature sensitive and the VTFPF is tuned by changing the temperature of the N modules of the VTFPF. A feature of the VTFPF of the invention is that the temperatures of the N modules are independently controlled and independently changed. The underlying mechanism is illustrated in FIG. 9, where the resonance of a two module (N=2) VTFPF device is shown at two temperature states. Both modules begin at the first temperature state, i.e. 25 degrees C. In the second temperature state, the first module (etalon 1) is heated to 27.29 degrees C., while the second module (etalon 2) is heated to 27.37 degrees C. The main resonant frequency at the first temperature state is 191.6 THz. The main resonant frequency at the second temperature state is 191.65 THz.

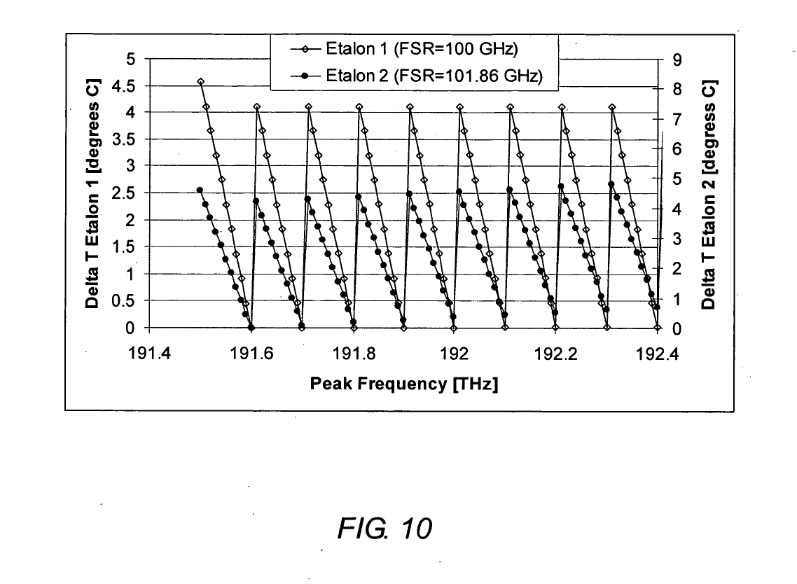

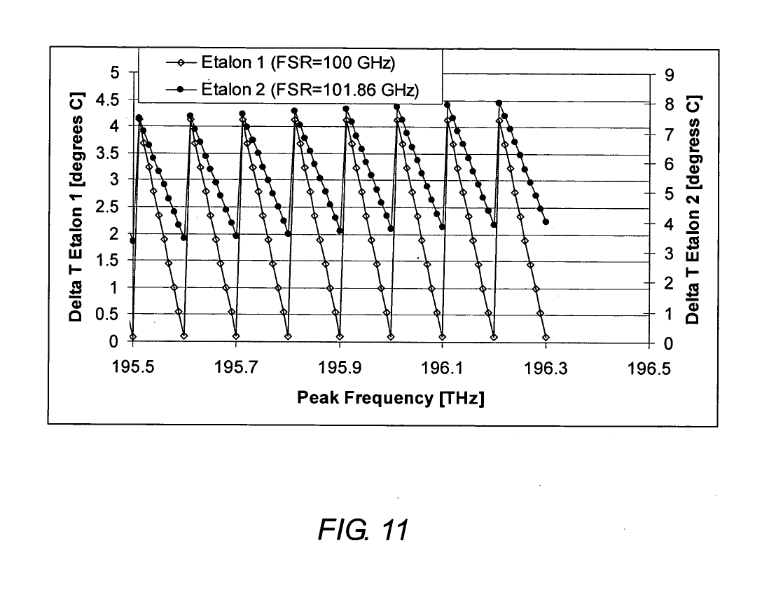

Multiple temperature states are used to scan the VTFPF over the frequency band of interest. In the embodiments shown here that band is approximately 191.5 THz to 196.5 THz (see FIG. 4). Other bands may be chosen. According to one aspect of the invention the temperature of the N modules is cycled many times over a relatively small temperature range to produce a scan of the entire frequency band. This is illustrated in FIGS. 10 and 11. For simplicity these figures show only a portion of the frequency band. FIG. 10 shows the temperature cycles for the frequency band 191.5 THz to 192.4 THz, and FIG. 11 shows the temperature cycles for the frequency band 195.5 THz to 196.5 THz. Each figure shows 9 cycles. It will be understood that for a VTFPF designed for the entire frequency range these illustrations represent a continuum over the band 191.5 THz to 196.5 THz. Each cycle traverses 0.1 THz, so a scan over the entire band in the embodiment represented by FIGS. 10 and 11 would have approximately 50 cycles.

The temperatures are shown as deltas from a base temperature. This is intended to indicate that the base temperature may vary over a wide range, e.g., 0-400 degrees C. The base temperature may also be below room temperature. For clarity, the temperature cycles of the two etalons are shown on separate temperature scales, with the temperature cycle of etalon 1 referenced to the scale to the left of the figures and the temperature of etalon 2 is referenced to the scale on the right.

The cycles shown in FIG. 10 follow a sawtooth pattern. However, the shape of the pattern is not critical to the operation of the invention. The up and down steps may have any suitable shape. A sinusoidal pattern may be preferred in some cases.

The absolute temperature range of the temperature cycles in FIGS. 10 and 11 is less than 5 degrees C. For other applications a different set of temperature ranges may be used. To obtain the benefits of the invention, i.e., thermally cycling the etalons over a small temperature range, the cycled temperature range may be less than 30 degrees C., and preferably less than 10 degrees C.

A temperature cycle is defined as a change in temperature from T1 to T2. At any given time during a scan the temperature of etalon N1 is defined as T_{N1} and the temperature of etalon N2 is T_{N2}. Etalon N1 is cycled between T1_{N1} and T2_{N1}. The range for that cycle is ΔT_{N1}. Etalon N2 is cycled between T1_{N2} and T2_{N2}. The range for that cycle is ΔT_{N2}.

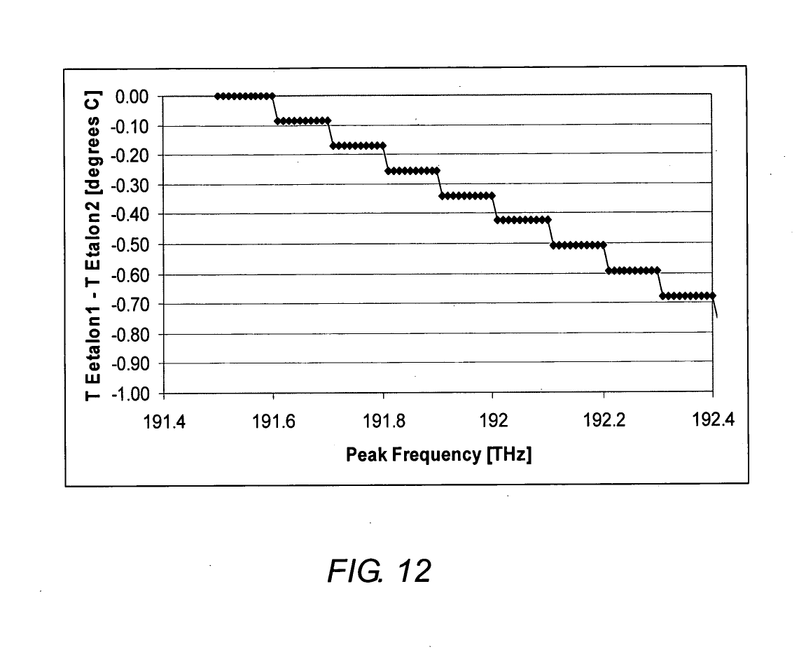

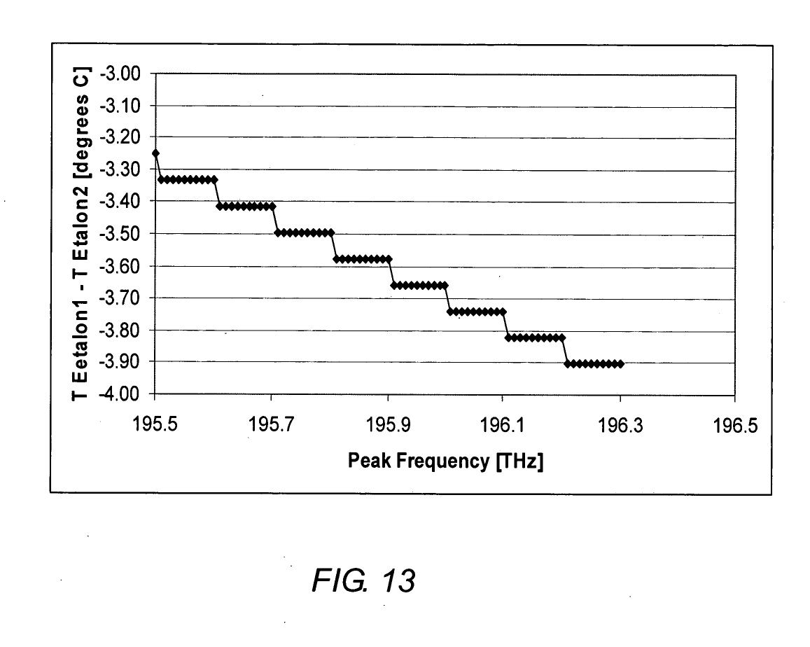

Close inspection of the cycles in FIGS. 10 and 11 reveals that etalon N1 is cycled between the same two temperatures, T1_{N1} and T2_{N1}, over a range of 4.1 degrees C. However, etalon N2 is cycled over the same absolute temperature range, 4.1 degrees C., but the temperatures T1_{N2} and T2_{N2} change stepwise from cycle to cycle during the scan. It will also be appreciated that the temperature difference between etalon 1, T_{N1} and etalon 2, T_{N2}, is fixed during each cycle, but increments from cycle to cycle. This is an important feature of the invention, and is illustrated in FIGS. 12 and 13. These figures each show nine cycles, and the temperature difference increment between etalon 1 and etalon 2 during each cycle. The temperature difference increment from cycle to cycle in this embodiment is 0.085 degrees C., i.e., in general terms, less than 0.1 degree C.

The temperature difference increment between cycles may vary substantially depending on the number of cycles used, which in turn depends on the application and the precision of the scan. Typically the temperature difference increment from cycle to cycle in a stepped or other cycle pattern in likely commercial applications will be less than 1.0 degree C.

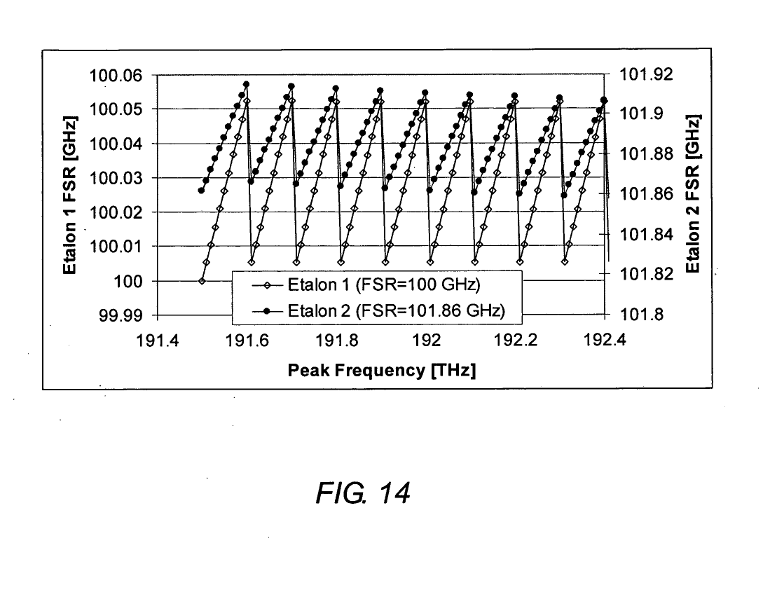

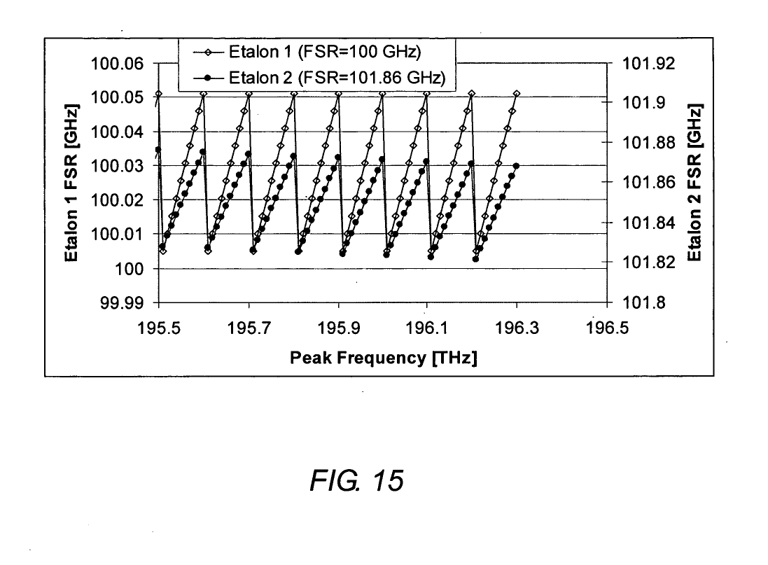

FIGS. 14 and 15 illustrate the variation in the FSRs of each etalon as a result of the temperature cycling shown in FIGS. 12 and 13. The FSR range per cycle for each etalon is approximately 0.05 GHz per cycle.

Two modules (N=2) in the device is the minimum for the devices described here. It is anticipated that more demanding applications may require at least three modules.

The temperature of each module should be aligned to match the FSR peak of the associated etalon at the desired tuning frequency. To maintain the filter shapes and the FSR alignment such that the ACR degrades by, for example, less than 1 dB, the tuning temperatures is preferably accurate to ±0.01° C. The accuracy may vary significantly depending on the application. In general, devices constructed according to the invention will have VTFPF modules with a temperature variation tolerance of less than ±0.1° C. It should be understood that when temperatures are referred to as “equal” or “the same” these tolerances are to be inferred.

It will be understood that since the temperature of each module is independently controlled, each module should be physically separate from other modules, and sufficiently removed to allow the temperature of the etalon(s) in each stage to be independently controlled.

The VTFPFs of primary interest here are for optical transmission systems that typically operate with a wavelength band centered at or near 1.55 microns. The wavelength range desired for many system applications is 1.525 to 1.610 microns. This means that the materials used for the etalons should have a wide transparent window around 1.55 microns. However, VTFPF devices are useful for other wavelength regimes as well, such as 1.310 microns.

The structure of the Fabry-Perot etalons is essentially conventional, each comprising a transparent plate with parallel boundaries. A variety of materials may be used, with the choice dependent in part on the signal wavelength, as just indicated, and the required temperature tuning range. The optical characteristics of etalons vary with temperature due to at least two parameters: the variation of refractive index with temperature, commonly referred to as the thermo-optic effect, and written as dn/dt, which changes the optical path length between the optical interfaces, and the coefficient of thermal expansion (CTE) which changes the physical spacing between the optical interfaces. In standard etalon device design, the optical sensitivity of the device to temperature changes is minimized. Materials may be chosen that have low dn/dt, and/or low CTE. Materials may also be chosen in which the dn/dt and the CTE are opposite in sign and compensate. Common materials for etalons are fused quartz, tantalum pentoxide or niobium pentoxide. Semiconductor materials or glasses may also be used.

It is preferred that the VTFPFs of this invention be based on silicon as the bulk etalon substrate material. Silicon has a large thermo-optic coefficient and therefore is contra indicated for most optical devices. However, amorphous silicon, polysilicon, and preferably single crystal silicon, are recommended for the methods described here because a large thermo-optic coefficient is desirable. The thermo-optic coefficient of single crystal silicon is approximately 1.9 to 2.4×10⁻⁴ per degree K. over the temperature ranges used for tuning the etalons.

Typical cross section dimensions for the etalons are 1.8 mm square, with the optical active area approximately 1.5 mm square. As indicated above the thickness of the VTFPF etalons may be less than 1 mm, typically 0.05 to 1 mm. The dimensions of the etalons will affect how rapidly the temperature may change and thus the cycle time. The cycle time may vary widely depending on this and other variables. For most applications where the band pass of the filter is scanned the objective will be a rapid scan time. In these applications a scan time of less than 10 seconds may be used and is easily realized with state of the art etalon temperature controls.

The embodiments shown in FIGS. 1-8 produce VTFPF devices with fine tuning capability. However, important industrial applications may be found wherein it is desirable to have faster tuning. To achieve this, according to an alternative embodiment of the invention, one etalon performs only one cycle while the other(s) remains at a fixed temperature.

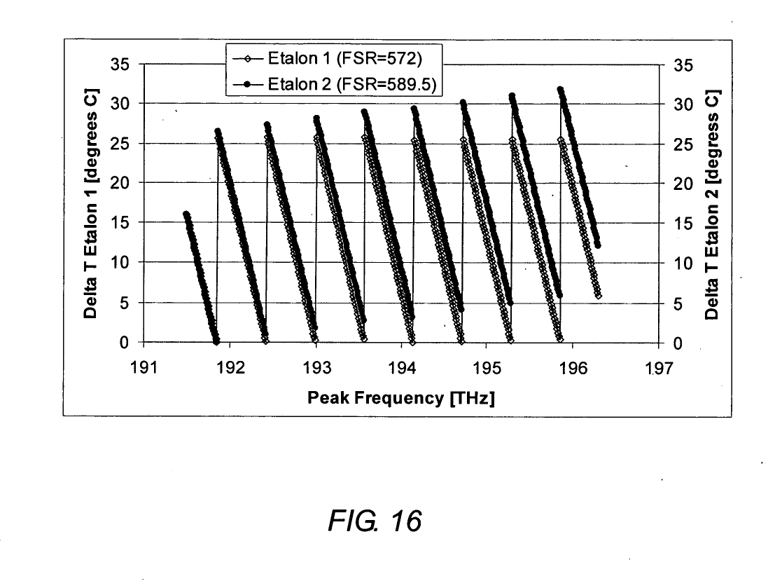

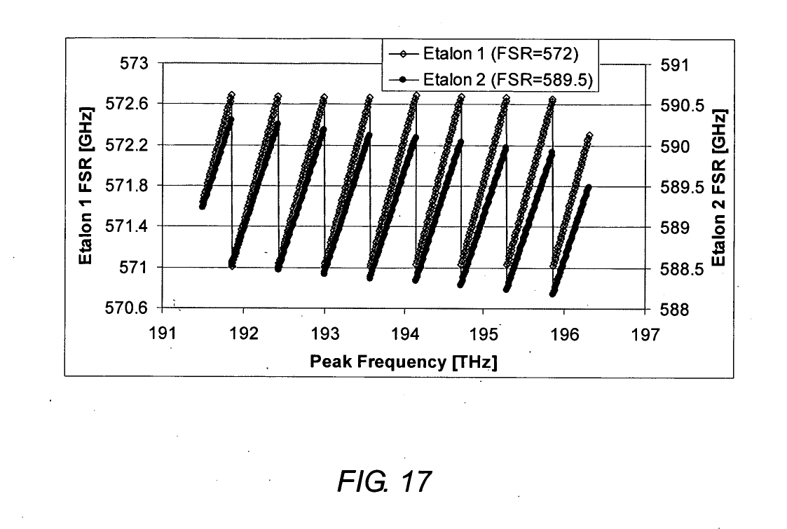

Another option for more rapid tuning is to divide the scan into fewer cycles and use etalons with larger FSRs. This option is illustrated in FIGS. 16 and 17 using a VTFPF with N=2. The FSR numbers are in GHz. Here the same 5 THz frequency band is scanned but with only nine cycles instead of fifty. FIG. 16 shows the temperature cycle range for this embodiment. The temperature range for each cycle is also more than five times that for the embodiments previously described, i.e., approximately 26 degrees C. FIG. 17 illustrates, for each etalon, the variation in FSR caused by the temperature cycles shown in FIG. 16. Each etalon has a larger FSR, more than five times that described in connection with FIGS. 1-8. The etalons have a nominal (room temperature) FSR of 572 GHz and 589.5 GHz respectively, a difference of 17.5 GHz. The variation in FSR in each etalon over the temperature cycles shown is approximately 1.75 GHz. This illustrates that the difference in FSR between etalon modules may be relatively large. For most practical embodiments of the invention the FSR difference will be at least 0.1 GHz. A range of 0.1 to 50 GHz is suitable.

As should be evident, the number of temperature cycles S used to scan a given frequency band may vary widely. The presence of any given number of cycles can be a useful indication of operation of the VTFPF according to the invention. Since the principle of the invention is, for a given frequency scan band, to divide the band into S sub-bands and cycle the temperature of the N etalons for each sub-band, the advantages of the invention may be considered realized if the scan is divided into at least three sub-bands and the temperature of the etalons is cycled at least three times (S=3) during the scan. However, more optimum vernier operation will be realized if the overall scan is divided into a larger number of sub bands. Typically this will be more than 7 and the N etalons will be cycled more than 7 times for each scan.

Other alternative embodiments include the use of multiple cavity etalons. For example, for a VTFPF device having N=2, a twin cavity etalon may be used. However the presence of a third inter mirror cavity creates a higher-order modulation on the filter transmittance, and unwanted coupling between the individual FP cavities becomes more severe as the spacing between etalons is reduced. Moreover, spacing the etalons closely interferes with the independent temperature control mentioned earlier. Accordingly it is preferred that the etalons be spaced apart by at least 1 mm. Also, with the etalon cavities separated one or more fiber-optic isolators may be used to control inter cavity coupling.

Other alternative embodiments may be designed with reflecting surfaces to fold the optical path. Supplemental lens arrangements may be used for steering or focusing the beam as desired. These kinds of device modifications are within the contemplation and scope of the invention.

Various additional modifications of this invention will occur to those skilled in the art. All deviations from the teachings of this specification that basically rely on the principles and their equivalents through which the art has been advanced are properly considered within the scope of the invention as described and claimed.

1. Method for tuning an optical filter wherein the optical filter comprises at least two Fabry-Perot etalon modules N₁ and N₂, the method comprising the steps of cycling the temperature of the modules through S cycles, wherein each of the S cycles comprises simultaneously changing the temperature T_{N1} of the N₁ module over a range of T_{Δ1} from T1_{N1} to T2_{N1} and changing the temperature T_{N2} of the N₂ module by T_{Δ2} from T1_{N2} to T2_{N2}, where the temperature difference T_{N2}−T_{N1} is fixed during each cycle and changes from cycle to cycle.

2. The method of claim 1 wherein S is at least 3.

3. The method of claim 2 wherein the temperature change occurs while an optical signal is transmitted through the optical filter.

4. The method of claim 2 wherein the Fabry-Perot etalon modules N₁ and N₂ each comprise a Fabry-Perot etalon with a Free Spectral Range (FSR) and the FSR of module N₁ is different from the FSR of module N₂ by at least 0.1 GHz.

5. The method of claim 4 wherein the FSR difference between module N₁ and module N₂ is in the range 0.1 to 50 GHz.

6. The method of claim 4 wherein T1_{N1} and T2_{N2}, are in the range 0-400 degrees C.

7. The method of claim 4 wherein T1_{N1} and T1_{N2} are the same during at least one of the S cycles.

8. The method of claim 4 wherein T_{Δ1} and T_{Δ2} are less than 30 degrees C.

9. The method of claim 4 wherein changing the temperature is effected by adjusting separate heating devices for each etalon stage.

10. The method of claim 4 wherein the temperature difference T_{N2}−T_{N1} changes from cycle to cycle by less than 1.0 degrees C.

11. The method of claim 4 wherein the optical signal has a center wavelength near 1.55 microns.

12. The method of claim 1 wherein S is more than 7.

13. Method for tuning an optical filter wherein the optical filter comprises at least two Fabry-Perot etalon modules N₁ and N₂, the method comprising the steps of cycling the temperature of the N₁ module through S=1 cycle, wherein the S cycle comprises changing the temperature N₁ module over a range of T_{Δ1} from T1_{N1} to T2_{N1} while maintaining the temperature of the N₂ module fixed.

14. An optical filter comprising:
a Fabry-Perot etalon module N₁,
an N₁ temperature control for controlling the temperature of module N₁,
a Fabry-Perot etalon module N₂, spaced from and optically aligned with module N₁,
an N₂ temperature control for controlling the temperature of module N₂, wherein temperature controls N₁ and N₂ simultaneously cycle the temperature of the modules through S cycles, wherein each of the S cycles comprises simultaneously changing the temperature T_{N1} of the N₁ module over a range of T_{Δ1} from T1_{N1} to T2_{N1} and changing the temperature T_{N2} of the N₂ module by T_{Δ2} from T1_{N2} to T2_{N2}, where the temperature difference T_{N2}−T_{N1} is fixed during each cycle and changes from cycle to cycle.

15. The optical filter of claim 14 wherein S is at least 3.

16. The optical filter of claim 15 wherein the Fabry-Perot etalon modules N₁ and N₂ each comprise a Fabry-Perot etalon with a Free Spectral Range (FSR) and the FSR of module N₁ is different from the FSR of module N₂ by at least 0.1 GHz.

17. The method of claim 16 wherein the FSR difference between module N₁ and module N₂ is in the range 0.1 to 50 GHz.

18. The optical filter of claim 16 wherein the etalon modules comprise silicon.

19. The optical filter of claim 18 wherein the etalons in the etalon modules comprise silicon slabs and the slab thickness is in the range 0.05 mm to 1 mm.

20. The optical filter of claim 16 wherein the optical filter comprises three Fabry-Perot etalon modules.
